(19) United States
(12) Patent Application Publication
(10) Pub. No.: US 2006/0267864 A1
(43) Pub. Date: Nov. 30, 2006

(54) Device and method of controlling the same

(75) Inventors: Akira Miyazawa, Saitama-shi (JP); Takahiro Kimura, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/442,271

(22) Filed: May 30, 2006

(30) Foreign Application Priority Data
May 30, 2005 (JP) 2005-157718

(51) Int. Cl. G09G 3/18

(52) U.S. Cl. 345/52

(57) ABSTRACT

According to one embodiment, a predetermined device is selected from a plurality of devices connected to a network, and an operation to request for a predetermined control is performed to the selected device. Then, it is determined whether or not a power supply of the selected device is in an on-state, and if it is in an on-state, the power supply of the device is turned on. An instruction corresponding to the requested predetermined control is issued to the device that is selected and is in an on-state, and the device is caused to perform the control.

### CROSS-REFERENCE TO RELATED APPLICATIONS

This application is based upon and claims the benefit of priority from Japanese Patent Application No. 2005-157718, filed May 30, 2005, the entire contents of which are incorporated herein by reference.

### BACKGROUND

1. Field

One embodiment of the invention relates to an audio/video (AV) apparatus which selectively controls a plurality of devices connected to a network and a method of controlling the same.

2. Description of the Related Art

As is generally known, in recent years, it has been possible to connect various devices including, for example, a television (TV) receiver, a set top box (STB), a digital versatile disk (DVD) recorder, and a personal computer (PC) via a predetermined digital interface such as i. Link (registered trademark), thereby configuring a network system.

In this kind of network system, a predetermined device is selected by use of an AV device having a video display panel, and an operation screen corresponding to the selected device is OSD (on-screen display) displayed on the video display panel, whereby the predetermined device can be controlled on the operation screen.

Meanwhile, such a network system requires various operations including an operation for selecting a specific device from a plurality of devices connected to a network, an operation for turning on the selected device, and an operation for controlling the selected device, and accordingly, its handling has become complicated to users.

Jpn. Pat. Appln. KOKAI Publication No. 2002-354351 discloses a configuration for automatically controlling an external device connected to a selected input in conjunction with input switching. In this case, as its control contents, for example, when a connected device is selected, it is turned on automatically to start replaying, and when it is not selected, it is turned off automatically to stop replaying.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram for explaining a record and replay apparatus according to an embodiment of the present invention;

FIG. 2 is a view for explaining an external appearance of a remote controller of the record and replay apparatus in the embodiment;

FIG. 3 is a flow chart for explaining an example of a main processing operation of the record and replay apparatus in the embodiment;

FIG. 4 is a view for explaining an example of a menu screen to be displayed at the processing operation of the record and replay apparatus in the embodiment;

FIG. 5 is a view for explaining an example of a device selection screen to be displayed at the processing operation of the record and replay apparatus in the embodiment; and

FIG. 6 is a flow chart for explaining another example of the main processing operation of the record and replay apparatus in the embodiment.

### DETAILED DESCRIPTION

Various embodiments according to the invention will be described hereinafter with reference to the accompanying drawings. In general, according to one embodiment of the invention, a predetermined device is selected from a plurality of devices connected to a network, and an operation to request for a predetermined control is performed to the selected device. Then, it is determined whether or not a power supply of the selected device is in an on-state, and if it is in an on-state, the power supply of the device is turned on. An instruction corresponding to the requested predetermined control is issued to the device that is selected and is in an on-state, and the device is caused to perform the control.

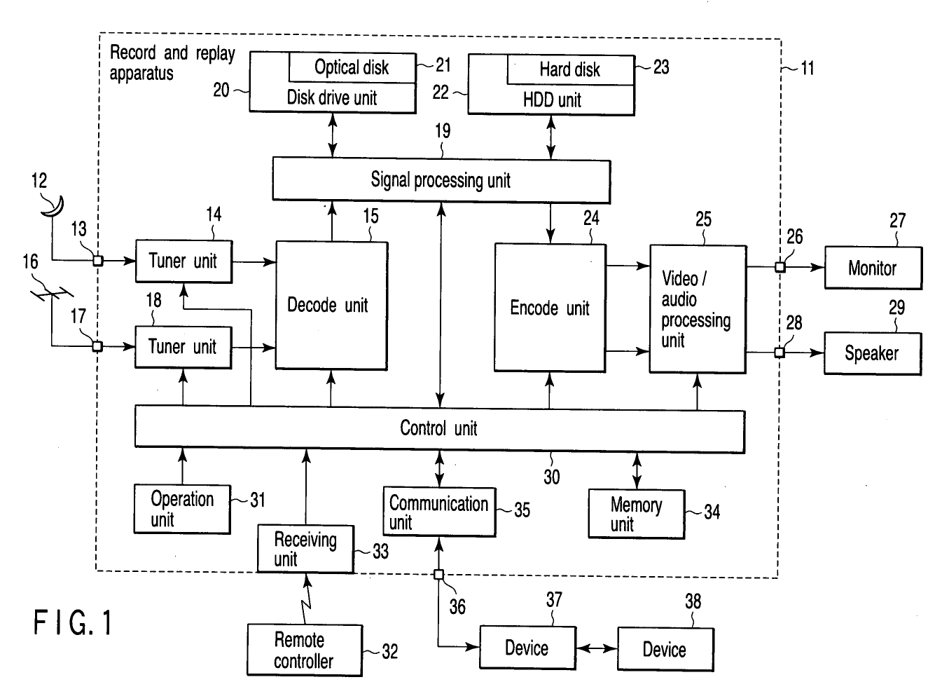

FIG. 1 shows a record and replay apparatus 11 as an AV device to be explained in this embodiment. In the figure, broadcast signals received by an antenna 12 for receiving satellite broadcasting are supplied via an input terminal 13 to a tuner unit 14 wherein a station selection process and a decode process are performed on the signals, and then, the signals are supplied to a decode unit 15.

Further, broadcast signals received by an antenna 16 for receiving terrestrial broadcasting are supplied via an input terminal 17 to a tuner unit 18 wherein a station selection process and a decode process are performed on the signals, and then, the signals are supplied to the decode unit 15.

The decode unit 15 selectively performs the decode process to the signals supplied from the respective tuner units 14 and 18. The signals decoded by the decode unit 15 are supplied via a signal processing unit 19 for recording to an optical disk 21 by a disk drive unit 20, and recording to a hard disk 23 by a hard disk drive (HDD) unit 22. Recording the signals to the optical disk 21 and recording the signals to the hard disk 23 may be performed selectively or simultaneously.

On the other hand, the signals recorded to the optical disk 21 are read by the disk drive unit 20 and supplied to the signal processing unit 19. Further, the signals recorded to the hard disk 23 are read by the HDD unit 22 and supplied to the signal processing unit 19. The signal processing unit 19 supplies the signals supplied from the disk drive unit 20 or the HDD unit 22 to an encode unit 24.

The encode unit 24 performs the encode process to the signals supplied from the signal processing unit 19, and thereby generates video signals and audio signals. The video signals generated by the encode unit 24 are subjected to a predetermined video signal process by a video/audio processing unit 25, and then supplied via an output terminal 26 for displaying video on an external monitor 27.

Meanwhile, the audio signals generated by the encode unit 24 are subjected to a predetermined audio signal process by the video/audio processing unit 25, and then supplied via an output terminal 28 for replaying audio by an external speaker 29.

Herein, the record and replay apparatus 11 totally controls all the operations thereof including the above-described record and replay operation by a control unit 30. The control unit 30 has a central processing unit (CPU) and the like therein. The control unit 30 receives operation information from an operation unit 31, or, operation information sent from a remote controller 32 via a receiving unit 33, and thereby controls the respective units such that the operation contents thereof are reflected.

In this case, the control unit 30 uses a memory unit 34. The memory unit 34 essentially includes a read only memory (ROM) having stored therein a control program executed by the CPU, a random access memory (RAM) that provides a work area to the CPU, and a nonvolatile memory in which various setting information and control information, etc. are stored.

Further, the control unit 30 is connected to a connection terminal 36 via a communication unit 35 conforming to the digital interface standard such as, for example, i. Link (registered trademark) and the like. To the connection terminal 36, various devices (two devices in the case illustrated) 37, 38 including, for example, a TV receiver, an STB, a DVD recorder, and a PC are connected to a network.

The control unit 30 is configured so as to make communication via the communication unit 35 with the respective devices 37 and 38, and selectively control a desired device.

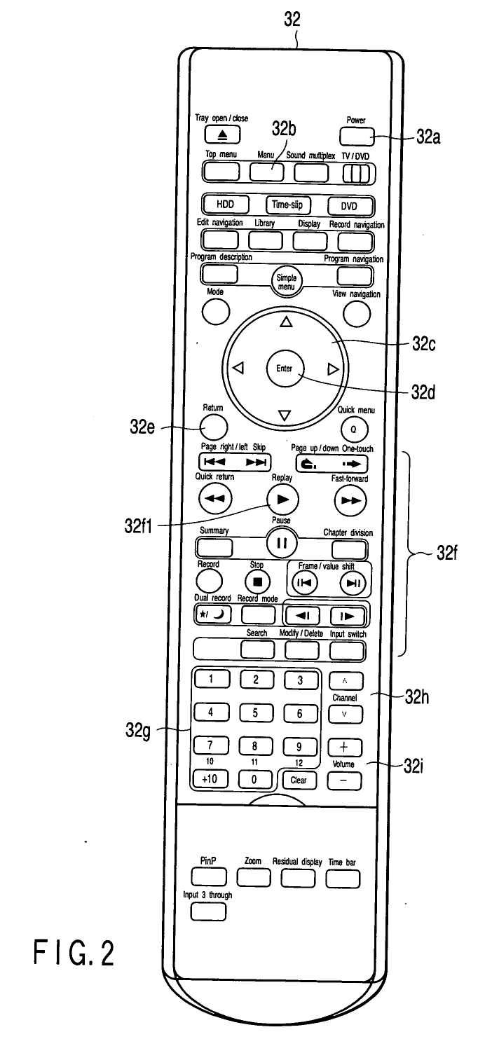

FIG. 2 shows an external appearance of the remote controller 32. The remote controller 32 mainly includes a power key 32a, a menu key 32b, a cursor key 32c, an enter key 32d, a return key 32e, keys 32f concerning record and replay control, numeric keys 32g, channel up/down keys 32h, volume adjustment keys 32i and the like.

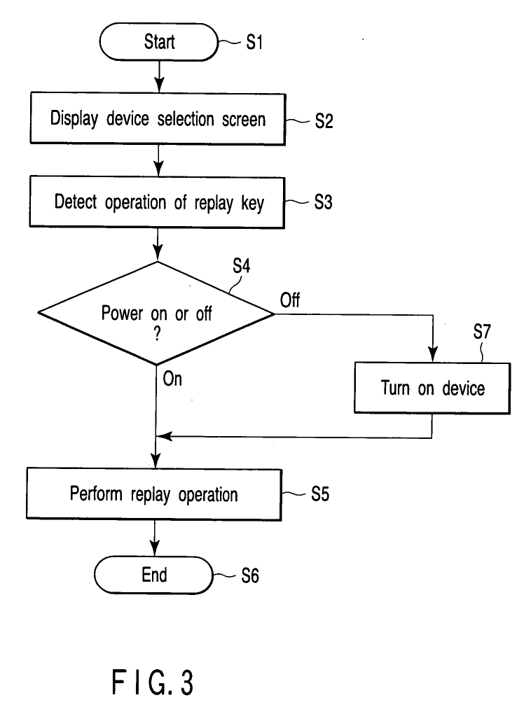

Next, the process for the record and replay apparatus 11 to selectively control the respective devices 37 and 38 connected to the network will be explained hereinafter. FIG. 3 shows a flow chart for explaining an example of the processing operation in the case where the device 37 is a record and replay device and the device 37 is caused to perform a replay operation.

The process is started when a user performs the operation to request for selecting a desired device from among the various devices 37 and 38 connected to the network (block S1). Then, the control unit 30 displays a device selection screen on the monitor 27 in block S2.

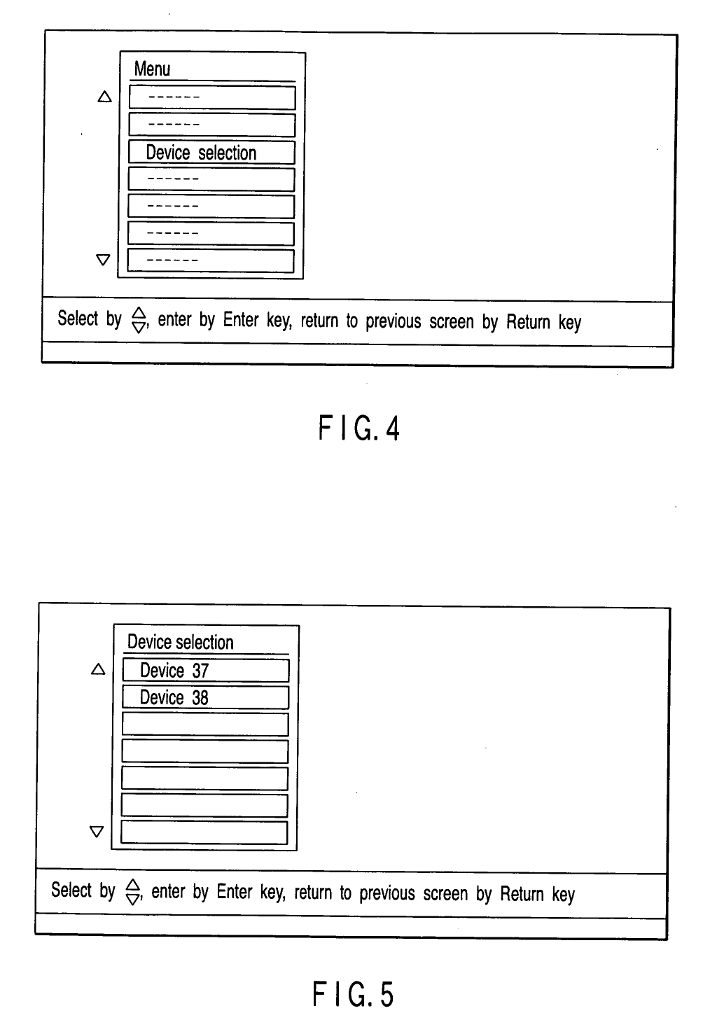

More specifically, when the user operates the menu key 32b of the remote controller 32, the control unit 30 displays a menu screen wherein various selection items are arranged on the monitor 27, as shown in FIG. 4.

When the user selects the item “device selection” from the various items displayed on the menu screen by use of the cursor key 32c, and operates the enter key 32d, the control unit 30 acquires information from all the devices 37, 38 connected to the network, and stores the information in the nonvolatile memory of the memory unit 34.

Thereafter, the control unit 30 refers to the contents of the nonvolatile memory, and as shown in FIG. 5, displays a device selection screen showing a list of all the devices 37, 38 currently connected to the network on the monitor 27. On the device selection screen, the user operates the cursor key 32c to select the device 37, and operates the enter key 32d, so that the control unit 30 selects the device 37.

Subsequently, when the control unit 30, in block S3, detects that the replay key 32f1 has been operated among the keys 32f concerning record and replay control of the remote controller 32, the control unit determines whether or not a power supply of the selected device 37 is in an off-state in block S4.

If it is determined that the power supply of the device 37 is in an on-state, the control unit 30 issues a replay instruction to the device 37 and causes the device to perform the replay operation in block S5, and completes the process (block S6).

Meanwhile, if it is determined that the power supply of the device 37 is in an off-state, the control unit 30 turns on the device 37 in block S7, and then, in block S5, issues a replay instruction to the device 37 to cause the device to perform the replay operation, and completes the process (block S6).

According to the processing operation example shown in FIG. 3, the desired device 37 is selected from the various devices 37 and 38 connected to the network, and the replay key 32f1 is operated, whereby the power supply of the device 37 is automatically turned on to enable the replay operation to be performed. Accordingly, it is unnecessary to turn on the selected device 37, and the control to the various devices 37 and 38 connected to the network can be realized by a simple operation, and consequently, usability can be improved.

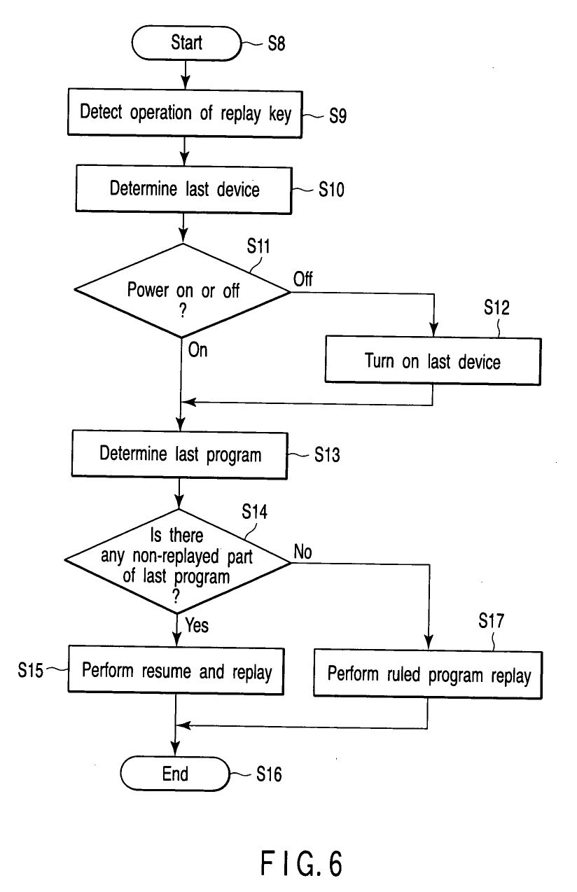

FIG. 6 shows a flow chart for explaining another example of the processing operation. That is, when the process is started (block S8), and the control unit 30 in block S9, detects that the replay key 32f1 of the remote controller 32 has been operated, the control unit 30 determines which is the device that has been controlled last (last device) in block S10.

With regard to the determination of the last device, identification information of the last device is stored in the nonvolatile memory of the memory unit 34 at the moment when the control of the last device is stopped. Consequently, by referring to the contents of the nonvolatile memory, the last device can be identified easily.

When the last device is determined in this manner, the control unit 30, in block S11, determines whether a power supply of the last device is in an on-state or off-state. If it is determined that the power supply of the last device is in an off-state, the control unit 30 turns on the last device in block S12.

After the block S12, or, if it is determined that the last device is turned on in block S11, the control unit 30 determines which is the program that has been replayed last by the last device (last program) in block S13.

With regard to the determination of the last program as well, identification information of the last program is stored in the nonvolatile memory of the memory unit 34 at the moment when the control of the last program is stopped. Consequently, by referring to the contents of the nonvolatile memory, the last program can be identified easily.

When the last program is determined in this manner, the control unit 30, in block S14, determines whether or not the last program has been replayed to the end thereof, namely, whether or not there is any non-replayed part of the last program.

Also with regard to the determination whether or not there is any non-replayed part of the last program, information showing a replay stop position of the last program is stored in the nonvolatile memory of the memory unit 34 at the moment when the control of the last device is stopped. Accordingly, by referring to the contents of the nonvolatile memory, the determination can be made easily.

If it is determined that there is any non-replayed part of the last program (YES), the control unit 30 causes the last device to resume and replay the non-replayed part in block S15, and completes the process (block S16).

On the other hand, if it is determined that there is no non-replayed part of the last program in the block S14, namely, that the last program has been replayed to the end thereof (NO), the control unit 30 causes the last device to perform a program replay operation based on a preset rule in block S17, and completes the process (block S16).

The ruled program replay in the block S17 includes various modes, such as, for example, automatic replay of a program recorded at the head, automatic replay of a program recorded at the end, automatic replay of a program recorded after the last program, automatic replay of a program recorded before the last program, and automatic replay of a program selected at random, among the programs recorded in the last device.

According to the processing operation example shown in FIG. 6, the user operates the replay key 32f1, whereby the last device is selected automatically and the program replay is performed. Therefore, for example, in the case where a same device is frequently used on a daily basis or the like, the operation of device selection is eliminated, and accordingly, usability for the user can be improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An AV device which selectively controls a plurality of devices connected to a network, the apparatus comprising:
a selector unit configured to display a device selection screen for selecting a predetermined device from said plurality of devices connected to the network, on the basis of information acquired from all the devices connected to the network;
an operation unit configured to cause the device selected by the selector unit to perform an operation to request for a predetermined control;
a power supply unit configured to turn on a power supply of the device when it is in an off-state on the basis of determining whether or not the power supply of the device selected by the selector unit is in an on-state; and
a control unit configured to issue an instruction corresponding to the predetermined control requested by the operation unit to the device which is selected by the selector unit and is in the on-state, and cause the device to perform the predetermined control.

2. An AV device which selectively controls a plurality of devices connected to a network, the device comprising:
an operation unit configured to cause the devices connected to the network to perform an operation to request for a predetermined control;
a determining unit configured to determine a last device that has been controlled last from among said plurality of devices connected to the network, on the basis of the operation of the operation unit;
a power supply unit configured to turn on the power supply of the device when it is in an off-state on the basis of determining whether or not a power supply of the last device determined by the determining unit is in an on-state; and
a control unit configured to issue an instruction corresponding to the predetermined control requested by the operation unit to the last device that is determined by the determining unit and is in the on-state, and cause the device to perform the predetermined control.

3. An AV device according to claim 2, wherein
the control unit,
when replay is requested in the operation unit, determines a last program replayed last by the last device,
if there is any non-replayed part in the last program, causes the last device to resume and replay the non-replayed part, and
if there is no non-replayed part in the last program, causes the last device to perform replay based on a preset rule.

4. An AV device according to claim 3, wherein
the replay based on the preset rule is one of, among programs recorded in the last device, automatic replay of a program recorded at the head, automatic replay of a program recorded at the end, automatic replay of a program recorded after the last program, automatic replay of a program recorded before the last program, and automatic replay of a program selected at random.

5. An AV device control method for selectively controlling a plurality of devices connected to a network, the method comprising:
an operation block of causing the devices connected to the network to perform an operation to request for a predetermined control;
a determination block of determining a last device that has been controlled last from among said plurality of devices connected to the network, on the basis of the operation in the operation block;
a power supply block of turning on a power supply of the device when it is in an off-state on the basis of determining whether or not the power supply of the last device determined in the determination block is in an on-state; and
a control block of issuing an instruction corresponding to the predetermined control requested in the operation block to the last device that is determined in the determination block and is in the on-state, and causing the device to perform the predetermined control.

6. An AV device control method according to claim 5, wherein
the control block,
when replay is requested in the operation block, determines a last program replayed last by the last device, and
if there is any non-replayed part in the last program, causes the last device to resume and replay the non-replayed part, and
if there is no non-replayed part in the last program, causes the last device to perform replay based on a preset rule.

7. An AV device control method according to claim 6, wherein
the replay based on the preset rule is one of, among programs recorded in the last device, automatic replay of a program recorded at the head, automatic replay of a program recorded at the end, automatic replay of a program recorded after the last program, automatic replay of a program recorded before the last program, and automatic replay of a program selected at random.
